(19) United States
(12) Patent Application Publication
(10) Pub. No.: US 2009/0192007 A1
(43) Pub. Date: Jul. 30, 2009

(54) Casing Structure for Torque Transmission Device

(75) Inventor: Noriyuki Sudou, Kanuma-shi (JP)

Correspondence Address: MORRISON & FOERSTER, LLP, 555 WEST FIFTH STREET, SUITE 3500, LOS ANGELES, CA, 90013-1024, US

(73) Assignee: Tochigi Fuji Sangyo Kabushiki Kaisha, Tochigi-shi (JP)

(21) Appl. No.: 12/418,421

(22) Filed: Apr. 3, 2009

Related U.S. Application Data
(63) Continuation of application No. 10/912,349, filed on Aug. 4, 2004.

(30) Foreign Application Priority Data
Jun. 8, 2003 (JP) 2003-287763

(51) Int. Cl. F16H 48/08; F16H 48/22

(52) U.S. Cl. 475/230; 475/231

(57) ABSTRACT

A casing structure for a torque transmission device is provided with a ring gear for receiving and transmitting torque with an external member so as to rotate around an axis and a casing rotating with the ring gear. The ring gear is provided with tapped holes. The casing is provided with a main casing having first through holes and a cover having second through holes. Bolts are respectively inserted through the first and second through holes and tightened in the tapped holes so that the casing is fixed to the ring gear. A diameter of the first throughholes differs from a diameter of the second throughholes.

### CROSS-REFERENCE TO RELATED APPLICATIONS

This application is a continuation of U.S. patent application Ser. No. 10/912,349, filed Aug. 4, 2004, the entire disclosure of which is incorporated by reference.

### BACKGROUND OF THE INVENTION

1. Field of the Invention

The present invention relates to a casing structure for a torque transmission device such as a differential and a transfer case for a vehicle.

2. Description of the Related Art

As is known, vehicles are equipped with various torque transmission devices such as a differential and a transfer case for transmitting torque generated by en engine to axles.

Japanese Patent Application Laid-open No. H09-89086 discloses a differential of a bevel gear type. The differential is capable of transferring torque given to a rotating differential case to a pair of side gears though allowing differential rotation therebetween by means of a differential gear set of a bevel type, which is provided with a pinion gear supported by a pinion shaft engaged with the side gears. Two parts of a main casing and a cover compose the differential case and are respectively provided with flanges for fixation. A ring gear for receiving torque from an engine and the flanges are conjointly fixed with each other by means of bolts.

### SUMMARY OF THE INVENTION

The main casing and the cover must be precisely positioned and centered because even slight eccentricity may lead to generation of severe vibration or friction with each other. For precise installation of the main casing, the cover and the ring gear, tolerance limits of bolt holes on the flanges and the ring gear must be strict.

As one method for achieving such precision machining, integrated machining has been now employed, in which machining is achieved in a condition that the cover is temporarily integrated with the main casing. The integrated machining requires production steps of temporary integration, machining with bolt holes, disintegration, rinse, re-integration and such. Such laborsome process increases the production cost of the torque transmission devices.

The present invention is achieved in view of solving the above problem.

According to an aspect of the present invention, a casing structure for a torque transmission device is provided with a first rotating member for receiving and transmitting torque with an external member so as to rotate around an axis, the first rotating member including one or more tapped holes; a second rotating member rotating with the first rotating member, the second rotating member including; a first part having one or more first through holes; a second part having one or more second through holes; and one or more bolts respectively inserted into the first and second through holes and tightened in the tapped holes, whereby the second rotating member is fixed to the first rotating member, wherein a first diameter of the first through holes differs from a second diameter of the second throughholes.

Preferably, the first part includes a first flange having the first through holes and the second part includes a second flange having the second through holes.

More preferably, the bolts are inserted from the first flange through the second flange or inserted from the second flange through the first flange.

Preferably, the first diameter is larger than the second diameter. Alternatively the second diameter is larger than the first diameter.

Still preferably, the bolts are respectively provided with neck portions substantially fitting with first or second through holes.

Further preferably, the second rotating member is provided with a fit portion configured to position and center the first part with respect to the second part.

Preferably, the casing structure is further provided with a third rotating member capable of rotating with respect to the second rotating member, the third rotating member being supported by and housed in the second rotating member.

More preferably, the second rotating member is provided with a support portion for supporting the third rotating member.

Still more preferably, the third rotating member is provided with a differential gear set.

Furthermore preferably, the casing structure is provided with a clutch for engagement between the second rotating member and the third rotating member.

### BRIEF DESCRIPTION OF THE DRAWINGS

FIG. 1 is a sectional view of a differential according to an embodiment of the present invention;

FIG. 2 is a partial sectional view of a casing structure of the differential; and

FIG. 3 is a partial sectional view of a casing structure of the differential according to a modified version.

### DETAILED DESCRIPTION OF THE PREFERRED EMBODIMENT

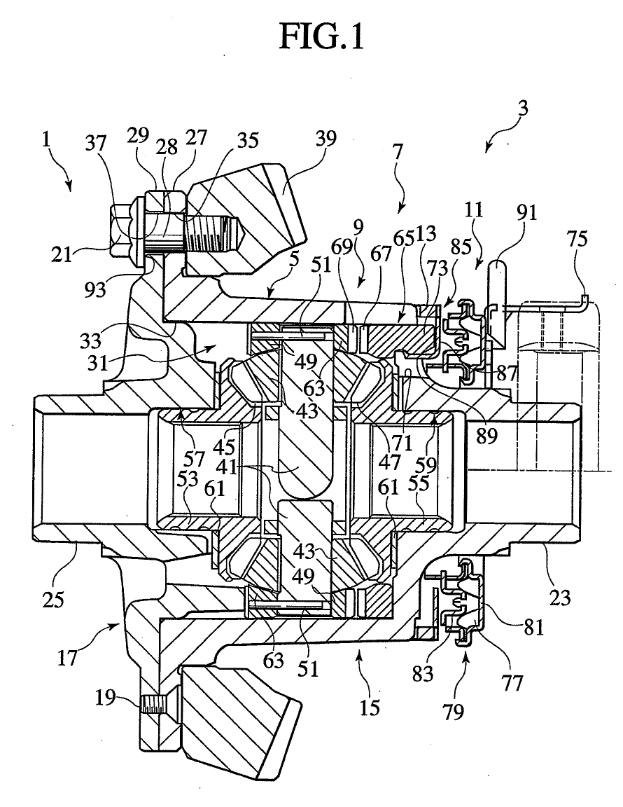

Certain embodiments of the present invention will be described hereinafter with reference to FIGS. 1 through 3. Throughout the specification and the drawings, definition of directions such as front and rear corresponds to directions of elements in practical use. Lateral directions of the drawings correspond to a lateral direction of the vehicle. In the description hereinafter, examples as a front differential will be described though the structure may be applied to a rear differential and a transfer case.

A differential 3 is generally applied to a front axle assembly of a four-wheel drive vehicle. However, of course, the differential 3 can be applied to a rear axle assembly with some modification.

Torque generated by the engine is transferred via a transmission to a transfer case and distributed to the front axle assembly and the rear axle assembly by the transfer case. The torque distributed to the rear axle assembly is transmitted to a rear differential via a rear propeller shaft. The rear differential distributes the torque to left and right rear axles and further to left and right rear wheels though allowing differential rotation of the left and right rear wheels. The torque distributed to the front axle assembly is transmitted to the front differential 3 via a front propeller shaft. Similarly, the torque is distributed to left and right front wheels though differential rotation of the wheels is allowed when four-wheel drive mode is ON by a 2-4 mode shift mechanism. On the contrary, when the 2-4 mode shift mechanism switches the drive mode to two-wheel mode, the front differential 3 is separated from the engine.

The differential 3 is provided with a differential casing 1, an inner casing 5, a differential gear set 7 of a bevel gear type, a dog clutch 9, a ring-like pneumatic actuator 11, a return spring 13 and such. The transfer case housed the differential 3 and is provided with oil reservoirs for lubricating the differential 3 and other elements.

The differential casing 1 is mainly composed of first and second parts, namely, a main casing 15 and a cover 17. The main casing 15 and the cover 17 respectively include boss portions 23 and 25, at which the differential casing 1 is supported by the transfer case. Bearings are interposed between the transfer case and the differential casing so as to assure smooth rotation. The main casing 15 and the cover 17 respectively include flanges 27 and 29 having bolt holes formed thereon at circumferentially even intervals and are fixed with each other by means of tap bolts 19 tighten in the bolt holes. The main casing 15 has an opening 31 facing toward left, which is covered by the cover 17. The cover 17 includes a positioning fit portion 33 configured to fit with an inner surface of the opening 31 so that the cover 17 and the main casing 15 are precisely positioned and centered with each other.

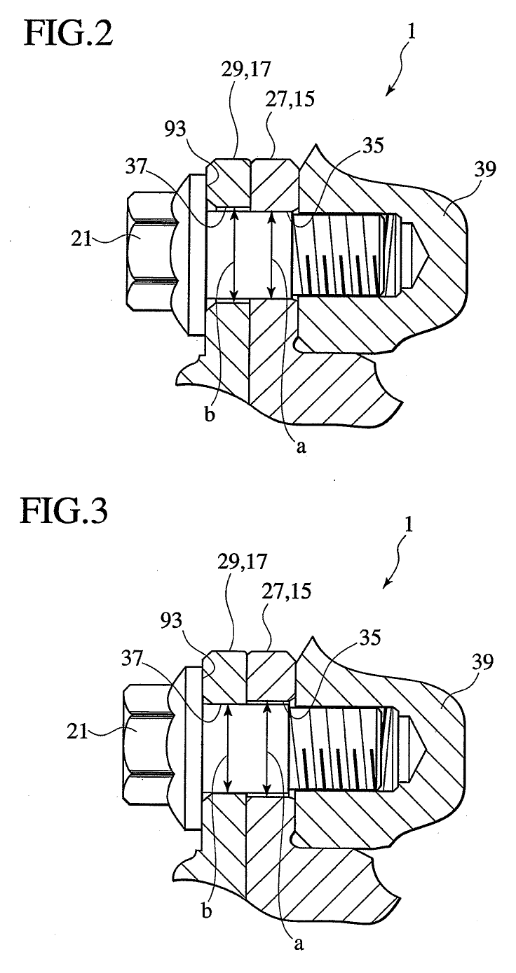

The flanges 27 and 29 are further provided with through holes 35 and 37 formed at circumferentially even intervals. The through hole 37 has a diameter b slightly larger than a diameter a of the through hole 35 as shown in FIG. 2. A ring gear 39 for input is provided with tapped holes respectively disposed correspondingly to the through holes 35 and 37. Bolts 21, each of which is composed of a head, a washer face 93, a neck portion 28 without a screw thread at a proximal end and a screw portion at a distal end, are inserted through the through holes 35 and 37 and tightened in the tapped holes so that the ring gear 39 is fixed to the flanges 27 and 29. The neck portion 28 substantially fit the through hole 35 but has a clearance with the through hole 37 because the through hole 37 has the slightly larger diameter b. The ring gear 39 is engaged with a driving pinion gear linked and rotated with the front propeller shaft and hence receives or transmits torque with the engine. Thereby the torque from the engine rotates the differential casing 1 around a laterally extending axis thereof.

Alternatively, the through holes 35 and 37 can be configured so that the diameter a is slightly larger than the diameter b as shown in FIG. 3. According to the alternative, the neck portion 28 substantially fit the through hole 37 but has a clearance with the through hole 35.

Difference between the diameter a and b is preferably around 0.2 mm and more preferably in a range from 0.1 to 0.3 mm. Making the difference below 0.1 mm is uneasy and making the difference beyond 0.3 mm may lose advantages therefrom. On the contrary, when the difference is set in the range from 0.1 to 0.3 mm, support portions 57 and 59 regularly support side gears 45 and 47 as described later.

The inner casing 5 is rotatably supported and housed in the differential casing 1.

The differential gear set 7 is provided with pinion shafts 41, pinion gears 43 respectively and rotatably supported by the pinion shafts 41 and a pair of output side gears 45 and 47. The pinion shafts 41 respectively engage with through holes 49 of inner casing 5 at both ends. Spring pins 51 are inserted for prevention of displacement of the pinion shafts 41. The side gears 45 and 47 respectively engage with the pinion gears 43 from both sides.

The side gears 45 and 47 respectively include boss portions 53 and 55, at which the side gears 45 and 47 are supported by the support portions 57 and 59 respectively formed in the cover 17 and the main casing 15. The boss portions 53 and 55 respectively link with left and right axles for output by means of respective splines. Thrust washers 61 are respectively interposed between the respective side gears 45 and 47 and the differential casing 1 so as to receive thrust force generated on the side gears 45 and 47. The inner casing 5 includes spherical washer portions 63 respectively receiving the pinion gears 43 so as to receive centrifugal force and engagement reaction force thereof.

The dog clutch 9 is composed of teeth 67 formed on a clutch ring 65 and teeth 69 formed on the inner casing 5. The clutch ring 65 is axially slidably supported in the main casing 15. The main casing 15 includes plural openings 71 formed at circumferentially even intervals, through which the oil circulates. The clutch ring 65 includes four legs 73 formed at circumferentially even intervals on the right end thereof, which engage with and projected outward from the openings 71.

The clutch ring 65 is capable of sliding leftward and rightward. When the clutch ring 65 moves leftward, the dog clutch 9 is engaged so that the inner casing 5 links and rotates with the differential casing 1. When the clutch ring 65 moves rightward, the engagement is cancelled so that the inner casing 5 is capable of free rotating.

The elements referred by the reference numerals 41, 43, 45, 47, 55 and 73 correspond to output members.

The pneumatic actuator 11 is formed in a ring-like shape and is disposed coaxially with the rotation axis of the differential casing 1 and the inner casing 5 around the boss portion 23. A support member 75 fixed with the transfer case anti-rotatively supports the pneumatic actuator 11. The pneumatic actuator 11 is provided with a base member 69 and a diaphragm 81 airtightly fixed thereto, which form a pressure chamber 77. A plunger member 83 is fixed to the diaphragm 81 so as to be capable of moving therewith. A retainer 85 is interposed between the plunger member 83 and the clutch ring 65.

The retainer 85 is provided with four retaining arms 87, which are disposed respectively correspondingly to the four legs 73 of the clutch ring 65. Each of the retaining arms 87 includes a retaining claw 89. The legs 73 are respectively latched between the retaining arms 87 and the retaining claws 89 so that the retainer 85 is coupled with the clutch ring 65.

Four return springs 13, disposed at circumferentially even intervals, are interposed between the retainer 85 and the right end of the main casing 15 so as to urge the clutch ring 65 to the right, thereby the dog clutch 9 is steadily urged to be cancelled.

The pressure chamber 77 of the pneumatic actuator 11 is connected to a compressor via an air pipe 91. Pressurizing the pressure chamber 77 displaces the diaphragm 81 leftward so that the plunger member 83 presses the retainer 85 leftward with overcoming repulsive force by the return springs 13, thereby the clutch ring 65 engages the dog clutch 9. On the contrary, depressurizing the pressure chamber 77 results canceling the engagement of the dog clutch 9 because the return springs 13 urges the retainer 85 rightward.

The dog clutch 9 is concurrently operated by the 2-4 mode shift mechanism which switches the drive mode between the four-wheel drive mode and the two-wheel drive mode.

In a case of the four-wheel drive mode, the dog clutch 9 is engaged. Then the torque generated by the engine is transferred to the differential casing 1 and distributed to the both front wheels. Not only the rear wheels but also the front wheels receive the torque from the engine so that traction of the wheels with the road can be easily maintained especially in a case of driving a bad road and such.

In a case of the two-wheel drive mode, the engagement of the dog clutch 9 is canceled. Thereby the inner casing 5 as well as the both front wheels comes to be freely rotatable. Then the torque transmission system from the 2-4 mode shift mechanism to the differential casing 1 is separated from both the engine and the front wheels so that the rotation thereof becomes to stop. Thereby, at the respective parts of the torque transmission system, vibration and abrasion accompanied with the rotation are suppressed. Furthermore, a load to the engine is reduced so that fuel efficiency is improved.

The boss portions 23 and 25 respectively include spiral oil grooves on the inner surfaces. The main casing 15 includes the openings 71 for oil circulation as mentioned above. The rotation of the differential casing 1 involves the oil circulation from the oil reservoirs through the oil grooves and the openings 71 and hence the oil spreads over a clearance between the main casing 15 and the inner casing 5, engagement points among the gears 43, 45 and 47, clearances between the pinion shaft 41 and the pinion gears 43, clearances between the main casing 15 and the clutch ring 65, the dog clutch 9 and such. Thereby these elements are lubricated and friction is reduced.

As mentioned above, the diameter a of the through holes 35 differs from the diameter b of the through holes 37, thereby the difference between the diameters a and b causes a tolerance of a position error involved with installation of the cover 17 with the main casing 15. Therefore, tolerance limits of the diameters a and b and position of the through holes 35 and 37 are eased and hence cost and difficulty of machining can be remarkably reduced.

Either the through holes 35 or the through holes 37 fit the neck portions 28 of the bolts 21 and hence directly receive the torque from the ring gear 39. Thereby the torque is securely transmitted to the main casing 15.

Integrated machining, in which machining is achieved in a condition that the cover 17 is integrated with the main casing 15, becomes unnecessary according to the present embodiment. Thereby, production steps concerning with temporary integration, machining with through holes, disintegration, rinse, re-integration and such are reduced and hence cost can be reduced.

Moreover, as compared with a case where both the through holes 35 and 37 have clearances to the bolts 21 so that only contact surface between the ring gear 39 transmits the torque to the main casing 15, either the through holes 35 or 37 as well can receive the torque. Thereby excessive load on the cover 17, the bolts 21 and the ring gear 39 can be prevented.

Rotation radius of the bolts 21 around the rotation axis of the main casing 15 can be relatively large so that force derived from the torque on the bolts 21 can be made relatively small. Therefore excessive load on the bolts 21 can be prevented. Furthermore torque fluctuation may not lead to loosening fixation torque of the bolts 21 and hence the fixation of the flange 27 and 29 can be assured for a long period of time.

Moreover, support members for output members, for example side gears 45 and 47, are composed of two parts of the main casing 15 and the cover 17. Thereby degree of freedom concerning with design are increased, especially when numbers of torque transmission members are housed in the differential casing.

Although the invention has been described above by reference to certain embodiments of the invention, the invention is not limited to the embodiments described above. Modifications and variations of the embodiments described above will occur to those skilled in the art, in light of the above teachings.

For example, the difference between the diameters a and b of the through holes 35 and 37 may be set larger than the range from 0.1 to 0.3 mm as long as the washer face 93 has enough contact area on the flange 29.

The arrangement of the flanges 27 and 29 and the ring gear 39 for input is not limited to the above description as shown in FIG. 1. For example, the ring gear 39 may be disposed most leftward, the flange 29 may be disposed to the right of the ring gear 39 and the flange 27 may be disposed further to the right of the flange 29. In this case, the bolts 21 are inserted from the right through the flanges 27 and 29 to the ring gear 39 and tightened.

In the above description, the differential 3 is exemplified as the intermissive transmission type, however, the casing structure may also applied to limited slip differentials, non-limited slip differentials, lock-up differentials, any transfer cases and any casings of various torque transmission devices. Alternative to the pneumatic actuator in the above example, any actuators such as hydraulic, electromagnetic and mechanical actuators may be applied.

What is claimed is:

1. A differential gear comprising:
a differential case rotatable around an axis, the differential case including;
a main casing including a first flange having a first through hole,
a cover including a second flange having a second through hole aligned with the first through hole, and
a fit portion configured to position the cover in place relative to the main casing;
a differential gear set housed in and rotatable with the differential case;
a ring gear configured to receive torque from an external member, the ring gear including a tapped hole aligned with the first through hole and the second through hole; and
a bolt inserted into the first and second through holes and tightened in the tapped hole, whereby the ring gear and the cover are fixed to the main casing, the bolt including a threaded portion and a non-threaded neck portion,
wherein diameters of the first through hole and the second through hole are differentiated and one selected from the group of the first through hole and the second through hole is so dimensioned as to fit on the neck portion of the bolt.

2. The differential gear of claim 1, wherein the fit portion is formed on the cover so as to fit in an inner surface of the main casing.

3. The differential gear of claim 1, wherein the bolts are inserted from the first flange through the second flange.

4. The differential gear of claim 1, wherein the first through hole is larger in diameter than the second through hole.

5. The differential gear of claim 1, wherein the second through hole is larger in diameter than the first through hole.

6. The differential gear of claim 1, wherein the differential case includes a support portion for supporting the differential gear set.

7. The differential gear of claim 1, further comprising:
a clutch configured to establish engagement between the differential case and the differential gear set so as to transmit the torque from the differential case to the differential gear set.

8. A differential gear comprising:
a differential case rotatable around an axis, the differential case including;
a main casing including a first flange having a first through hole,
a cover including a second flange having a second through hole aligned with the first through hole, and
a fit portion configured to position the cover in place relative to the main casing;
a differential gear set housed in and rotatable with the differential case;
a ring gear configured to receive torque from an external member, the ring gear including a tapped hole aligned with the first through hole and the second through hole; and
a bolt inserted into the first and second through holes and tightened in the tapped hole, whereby the ring gear and the cover are fixed to the main casing, the bolt including a threaded portion and a non-threaded neck portion,
wherein one selected from the group of the first through hole and the second through hole is so dimensioned as to fit on the neck portion and another is so dimensioned as to leave a clearance around the neck portion.

9. The differential gear of claim 8, wherein the fit portion is formed on the cover so as to fit in an inner surface of the main casing.

10. The differential gear of claim 8, wherein the bolts are inserted from the first flange through the second flange.

11. The differential gear of claim 8, wherein the first through hole is larger in diameter than the second through hole.

12. The differential gear of claim 8, wherein the second through hole is larger in diameter than the first through hole.

13. The differential gear of claim 8, wherein the differential case includes a support portion for supporting the differential gear set.

14. The differential gear of claim 8, further comprising:
a clutch configured to establish engagement between the differential case and the differential gear set so as to transmit the torque from the differential case to the differential gear set.
